(19) United States
(12) Patent Application Publication
(10) Pub. No.: US 2008/0302069 A1
(43) Pub. Date: Dec. 11, 2008

(54) Horse Bit

(75) Inventor: Lowell Dean Stevenson, Lindrith, NM (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: MACRAM PTY LTD, South Hobart, Tasmania (AU)

(21) Appl. No.: 12/066,990

(22) PCT Filed: Sep. 15, 2006
(86) PCT No.: PCT/AU06/01364

§ 371 Date: Aug. 21, 2008

(30) Foreign Application Priority Data
Sep. 15, 2005 (AU) 2005905106

(51) Int. Cl. B68B 1/06

(52) U.S. Cl. 54/8

(57) ABSTRACT

A horse bit (1) has a mouth bar (2) and two control bars (3). The mouth bar (2) is arched and is in the range of 5 mm to 10 mm in diameter and its length is dependent on the size of the horse. The control bars (3) are formed integrally with, and from the same material as, the mouth bar (2) and are located at opposed ends of the control bar (2). The mouth bar (2) and the control bars (3) are substantially coplanar. Each control bar (3) is angled inwardly and makes an angle that is in the range of 75° to 90° with the adjacent portion of the mouth bar (2).

### FIELD OF THE INVENTION

This invention relates to bits for the control of horses.

### BACKGROUND OF THE INVENTION

Horse bits presently on the market exert indirect pressure to a combination of many parts of the horse's mouth, tongue, cheek, or chin. This indirect pressure causes confusion to the horse and inhibits the learning process, particularly for young horses in the breaking in phase. Even older performance horses have trouble deciphering instructions from the rider especially with speed disciplines. They become confused and as a result react in certain ways that are unproductive such as head tossing and indecisive directional movement. This only results in the rider using excessive force on the reins which in turn creates problems for the horse's mouth due to severe pulling of the reins and depending on the type of bit being used complications arise. This is exacerbated when the rider is unskilled or impatient. Usually the end result is a hard or soft mouth and so the horse is devoid of proper control. The horse either has an oversensitive mouth which means he is in discomfort when pressure is applied and reacts accordingly or a non sensitive mouth which reduces the effectiveness of the command and tends to encourage the horse to become headstrong which often puts the rider in a dangerous situation. Mouthing problems during the initial training period cost time and money and often the end result is an uncommunicative horse. This is not only a problem for the weekend rider but also the professional trainer who works a lot of horses at any given time. Results need to be achieved not only in the shortest amount of time but be highly effective as well. Failing to yield with not only the head but neck as well is a common problem with horses ridden or trained with traditional bits. Another very common problem that occurs with most of the present bits is horses getting their tongues over the bits.

One problem of prior art bits is that they operate by applying pressure to the horse's bottom and/or upper jaw and mouth at the same time. As discussed above, this can be disadvantageous as the bit encourages the horse to “lean” on the bit with its entire neck and head, resulting in many problems; which include the horse throwing its head, a longer learning process for the horse and the horse undertaking a larger turning circle when ridden.

### SUMMARY OF THE INVENTION

This invention accordingly provides a bit for a horse comprising:
a two-ended mouth bar for insertion into the horse's mouth and over its tongue;
two downwardly extending control means, located one at each end of the cross member for positioning outside the horse's mouth adjacent the lower jaw;
each control means:
   comprising inwardly directed engagement means; and
   adapted to engage a region of the horse's lower jaw wherein, in use, the control means applies localised controlling pressure to the region.

It will accordingly be seen that embodiments of the present invention to provide a bit for a horse that applies more direct/controlled pressure and provides a higher level of comfort to the horse, and thus better “acceptance” of the bit by the horse.

### PREFERRED ASPECTS OF THE INVENTION

It is preferred that the mouth bar is rigid and that each control means is rigidly attached to the mouth bar.

More preferably, each control means is formed integrally with the mouth bar.

It is preferred that each engagement means is orientated at an angle that is in the range of 75° to 90° to the axis of its corresponding end of the mouth bar.

In one preferred form, the horizontal distance between the two ends of the mouth bar is in the range of 110 mm to 120 mm. In this case, it is preferred that the region of the mouth bar intermediate its two ends is in the range of 5 mm to 25 mm above the ends of the mouth bar.

In another preferred form the horizontal distance between the two ends of the mouth bar is in the range of 130 mm to 140 mm. In this case, it is preferable that the region of the mouth bar intermediate its two ends is in the range of 10 mm to 30 mm above the ends of the mouth bar.

Preferably the bit further comprises means adapted to engage the horse's lower jaw sufficiently to retain the bit in position in the horse's mouth. It is particularly preferred that the means adapted to engage the horse's lower jaw is a chin strap.

It is preferred that the bit further comprises rein-attachment means. Alternative preferred locations for the rein-attachment means are at or near the upper end of the control means, and at or near the lower end of the control means.

### BRIEF DESCRIPTION OF THE DRAWINGS

Preferred embodiments of the invention are described below with reference to the following drawings in which:

FIG. 1 is a perspective view from the front of a bit according to a preferred embodiment of the present invention, showing the bit with reins and bridle attached;

FIG. 2 is a perspective view of the embodiment of FIG. 1, from a different view point;

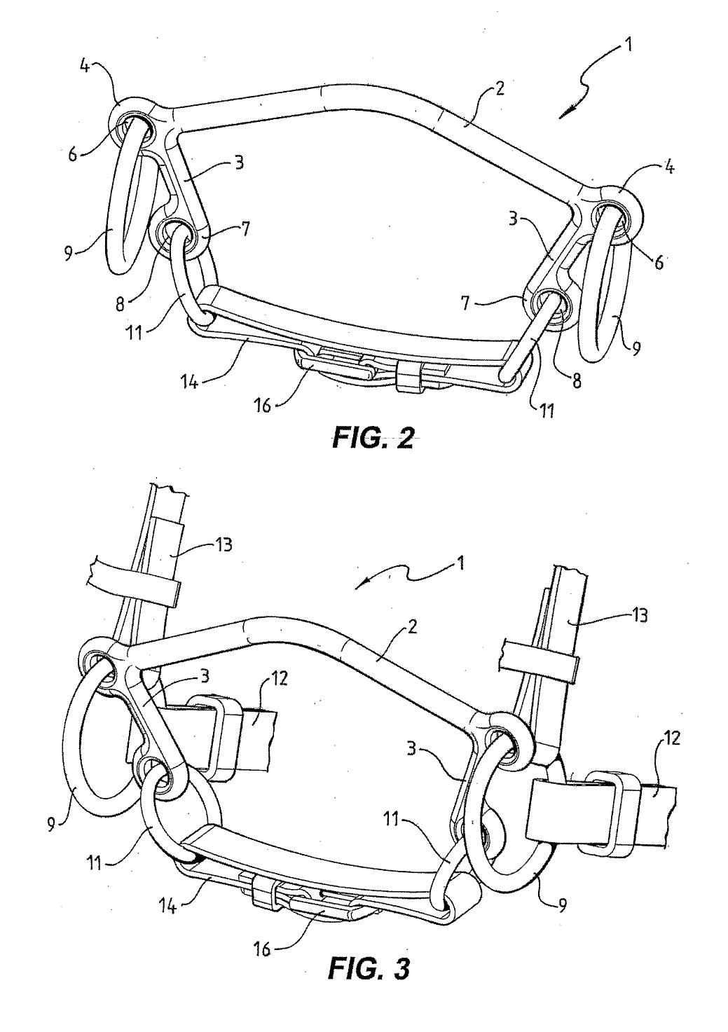

FIGS. 3, 4 and 5 are perspective vies of the embodiment of FIG. 1 showing the bit with reins and bridle attached; and

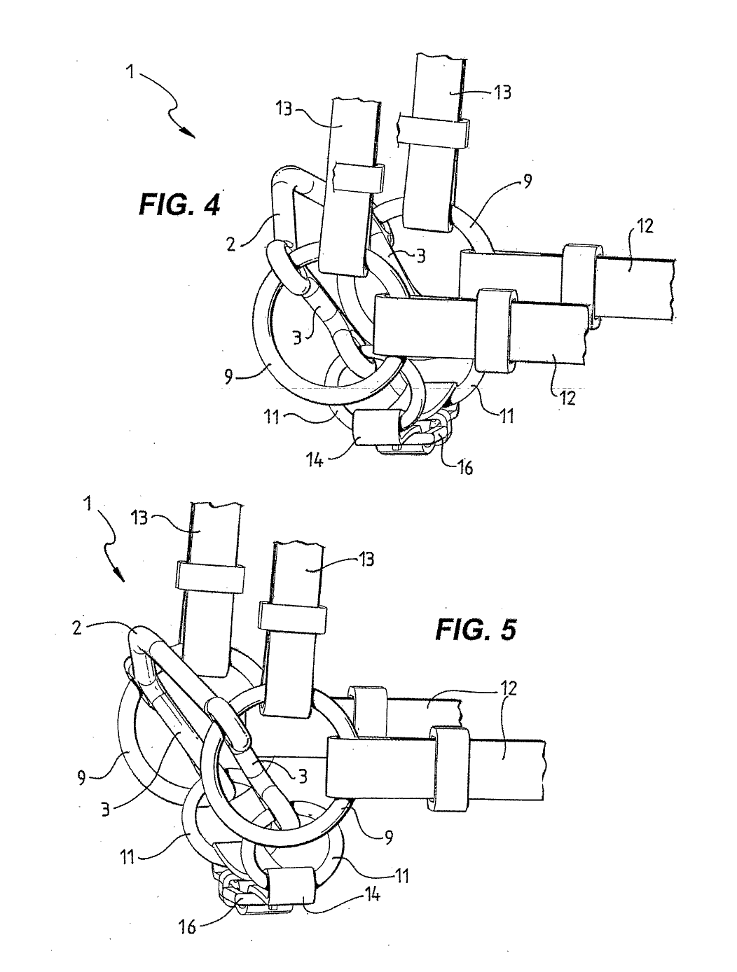

FIG. 6 is a drawing, partly illustrating hidden internal detail, of a horse wearing a bit according to an embodiment of the present invention.

### DESCRIPTION OF PREFERRED EMBODIMENTS OF THE INVENTION

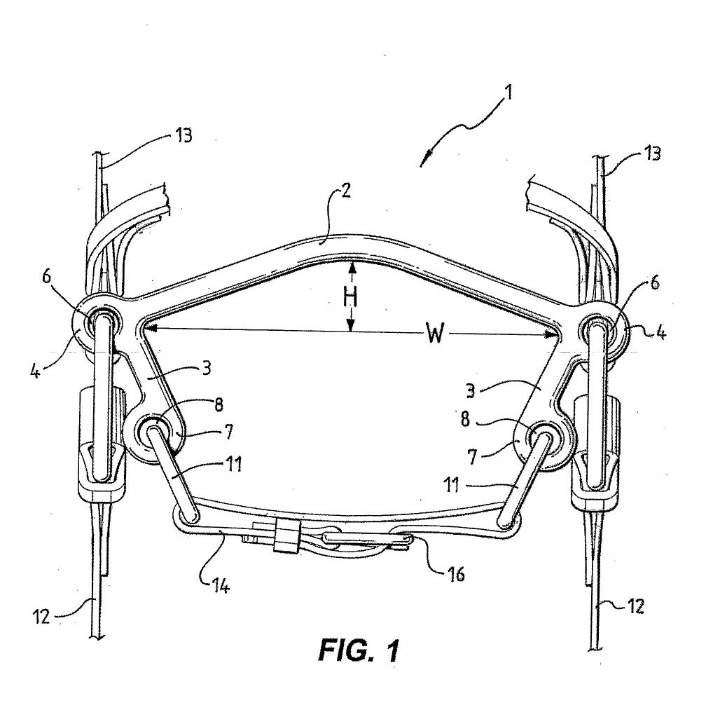

As is shown in FIG. 1, the bit 1 has a mouth bar 2 and two control bars 3.

The mouth bar 2 is arched and is fabricated from any suitable rigid material, but sweet iron is preferred because it encourages extra saliva and promotes mouth comfort. The mouth bar 2 is in the range of 5 mm to 10 mm in diameter and its length is dependent on the size of the horse. In the embodiment of the invention that is shown in FIG. 1, the dimension of the mouth bar 2 shown as “W” in that drawing (the effective length of the mouth bar when it is in a horse's mouth) is 115 mm for most horses and the dimension shown as “H” in the drawing (the amount by which the mouth bar is arched away from being in a straight line) is in the range of 5 mm to 25 mm.

According to another embodiment of the invention, designed for larger horses such as draft horses, the dimension “W” is 135 mm in which case the dimension H is in the range of 10 mm to 30 mm.

The control bars 3 are formed integrally with, and from the same material as, the mouth bar 2 and are located at opposed ends of the control bar 2. The mouth bar 2 and the control bars 3 are substantially coplanar. Each control bar 3 is angled inwardly and makes an angle that is in the range of 75° to 90° with the adjacent portion of the mouth bar 2. It is preferred that the control bars are in the range of 30 mm to 70 mm in length. For the embodiment of the invention in which the length “W” of the mouth bar is 115 nm, the preferred length of each control bar is 45 mm. For the embodiment of the invention in which the length “W” of the mouth bar is 135 mm, the preferred length of each control bar is 60 mm.

Adjacent the junctions of the mouth bar 2 and each control bar 3, the bit has integrally-formed upper attachment points 4. Each upper attachment point 4 has an aperture 6 extending through it in the direction substantially normal to the plane in which the mouth bar 2 and the control bars 3 lie.

Remote from the mouth bar 2, each control bar 3 terminates in an integrally-formed lower attachment point 7. Each lower attachment point 7 has an aperture 8 extending through it in the direction substantially normal to the plane in which the mouth bar 2 and the control bars 3 lie.

Each upper attachment point 4 is adapted to receive an upper attachment ring 9 which is retained in the aperture 6. The upper attachment ring 9 is adapted to be an attachment point for tack such as reins 12 and bridle cheek-piece 13.

Each lower attachment point 7 is adapted to receive a lower attachment ring 11 which is retained in the aperture 8. The lower attachment ring 11 is adapted to receive a chin-strap 14. The chin strap 12 has and adjuster 16 to enable insertion and replacement of the chin-strap 14 within the lower attachment rings 11 and to allow for adjustment of the effective length of the chin-strap 14.

The upper and lower attachment rings 9 and 11 can be fabricated from the sane material as is the mouth bar 2. Alternatively, they can be fabricated from a material that is different from the material of the mouth bar 2. A preferred material for the attachment rings 9 and 11 is stainless steel. It is preferred that the chin-strap 14 is made of leather.

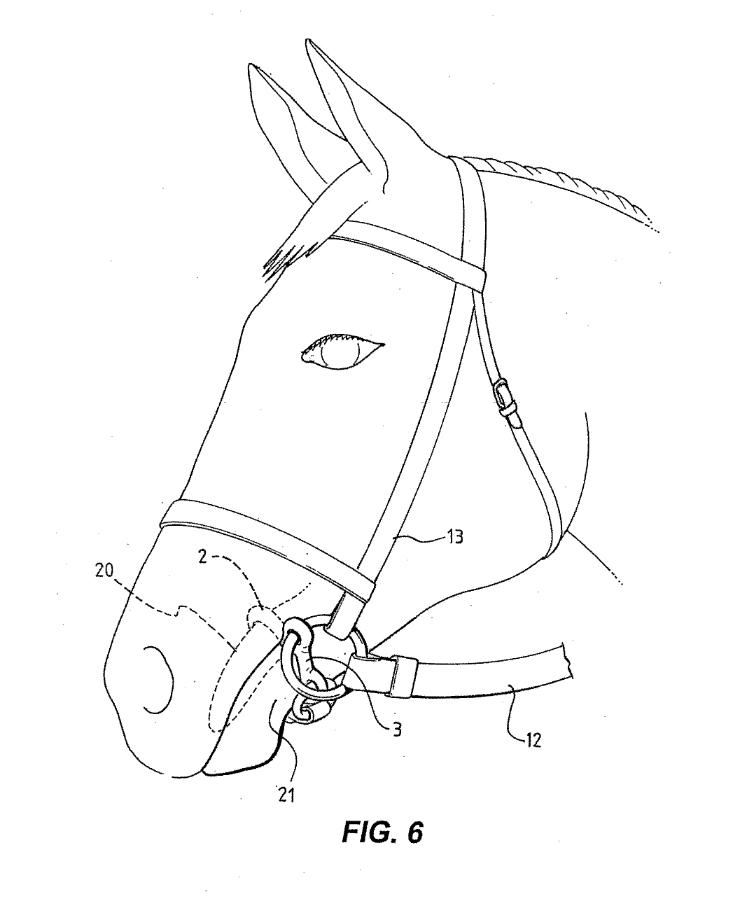

In use, the bit 1 is placed in the horse's mouth like a conventional bit, with the mouth bar 2 resting in the bar of the mouth (the interdental space behind the front incisors and in front of the back molars). The mouth bar lies over the horse's tongue 20 as is illustrated in FIG. 6. Each of the control bars 3 depends downwardly from the mouth bar 2 adjacent the horse's lower jaw 21 to provide direct pressure against a small area at each side of the jaw 21. This direct pressure provides the horse with a far more direct cue than with the many pressure points provided with most traditional bits. This direct pressure over a concentrated area clarifies the instruction to the horse far more clearly and rapidly. It also encourages the horse to yield with its head and as well as its neck. The chin-strap 14 passes under the lower jaw to stop the bit lifting up in the mouth.

Although the reins 12 are shown as attached to the upper attachment rings 9, they can be switched to the lower attachment rings 11 to provide greater directness of pressure to the lower jaw, but the upper attachment rings 9 are the preferred position.

While the present invention has been described with reference to a few specific embodiments, the description is illustrative of the invention and is riot to be construed as limiting the invention. Various modifications may occur to those skilled in the art without departing from the true spirit and scope of the invention as defined by the appended claims.

‘Comprises/comprising’ when used in this specification is taken to specify the presence of stated features, integers, steps or components but does not preclude the presence or addition of one or more other features, integers, steps, components or groups thereof.

1. A bit for a horse comprising:
a two-ended mouth bar for insertion into the horse's mouth and over its tongue;
two downwardly extending control means, located one at each end of the cross member for positioning outside the horse's mouth adjacent the lower jaw;
each control means:
comprises inwardly directed engagement means; and
adapted to engage a region of the horse's lower jaw wherein, in use,
the control means applies localised controlling pressure to the region.

2. A bit for a horse as claimed in claim 1, in which the mouth bar is rigid.

3. A bit for a horse as claimed in claim 1, in which each control means is rigidly attached to the mouth bar.

4. A bit for a horse as claimed in claim 1, in which each control means is formed integrally with the mouth bar.

5. A bit for a horse as claimed in claim 1, in which each engagement means is orientated at an angle that is in the range of 75° to 90° to the axis of its corresponding end of the mouth bar.

6. A bit for a horse as claimed in claim 1, in which the horizontal distance between the two ends of the mouth bar is in the range of 110 mm to 120 mm.

7. A bit for a horse as claimed in claim 6, in which the length of each control means is in the range of 30 mm to 70 mm.

8. A bit for a horse as claimed in claim 7, in which the length of each control means is substantially 45 mm.

9. A bit for a horse as claimed in claim 6, in which the region of the mouth bar intermediate its two ends is in the range of 5 mm to 25 mm above the ends of the mouth bar.

10. A bit for a horse as claimed in claim 1, in which the horizontal distance between the two ends of the mouth bar is in the range of 130 mm to 140 mm.

11. A bit for a horse as claimed in claim 10, in which the length of each control means is in the range of 30 mm to 70 mm.

12. A bit for a horse as claimed in claim 11, in which the length of each control means is substantially 60 mm.

13. A bit for a horse as claimed in claim 10, in which the region of the mouth bar intermediate its two ends is in the range of 10 mm to 30 mm above the ends of the mouth bar.

14. A bit for a horse as claimed in claim 1, further comprising means adapted to engage the horse's lower jaw sufficiently to retain the bit in position in the horse's mouth.

15. A bit for a horse as claimed in claim 14, in which the means adapted to engage the horse's lower jaw is a chin strap.

16. A bit for a horse as claimed in claim 1, further comprising rein-attachment means.

17. A bit as claimed in claim 16, in which the rein-attachment means is located at or near the upper end of the control means.

18. A bit for a horse as claimed in claim 16, in which the rein-attachment means is located at or near the lower end of the control means.

19. A bit for a horse as claimed in claim 1, substantially as described with reference to drawings.

20. A bit for a horse, substantially as described with reference to the drawings.
